(19) United States
(12) Patent Application Publication
(10) Pub. No.: US 2019/0392722 A1
(43) Pub. Date: Dec. 26, 2019

(54) Versatile Interactive Educational Activity and Play table

(71) Applicants: Ambrose Commissariat, Sunnyvale, CA (US); Diana Commissariat, Sunnyvale, CA (US)

(72) Inventors: Ambrose Commissariat, Sunnyvale, CA (US); Diana Commissariat, Sunnyvale, CA (US)

(21) Appl. No.: 16/014,089

(22) Filed: Jun. 21, 2018

(51) Int. Cl. G09B 5/06; G09B 19/22; A63F 13/2145; A47B 21/02

(52) U.S. Cl. CPC G09B 5/065; G09B 19/22; A47B 2200/0073; A47B 21/02; A63F 13/2145

(57) ABSTRACT

This invention is a versatile computerized table which can be used as an easel or a presentation device, play and activity station for kids and a regular table. It has a table top which is two sided with one side computerized and the other side is either magnetic, chalk or plain surface. This table top is mounted onto the base of the table by two adjustable connectors which are capable of rotating the table top at different angles on the table base. The base of the table has either indentations or pull out slots that would hold the table base at different positions. The table has adjustable legs or rollers that lock in place that can be configured at different heights.

### BACKGROUND OF THE INVENTION

This invention is an educational and entertainment device under US Patent class category number 434 (Education and demonstration). It is a versatile tool that can be used by both kids and teachers for learning and activity purposes.

The intent of this table is to revolutionize the way children play and learn by making classrooms more hi-tech, which, if small in size can still accommodate many varied activities to keep the child engaged and learning. This kind of table will benefit Preschools, home daycares, and also individual homes where parents are always challenged at keeping their children engaged and productive. It could be used at the restaurants, malls or commercial play areas to keep children engaged and happy while parents are busy completing business. The motive is to keep the children engaged, entertained, learning and having fun without making a mess, or being bored with toys that do not talk, walk or interact. It will eliminate the need for space for storing bulky toys, and the space to play with them. It will make clean up a breeze. It will take away the need to constantly replace broken toys, also taking away the need to replace the toys that children have either outgrown or are just bored with. It will make playtime more interactive, engaging whilst building their tech skills, making education more enticing, and keep them wanting more. This will also contribute to saving paper and the environment in a big way. It will transform the way teachers teach by helping them deliver their lesson through interactive games, drills, music and visual displays etc.

### BRIEF SUMMARY OF THE INVENTION

A hi-tech touch-screen table that can be a play/activity-station for kids and when needed be converted to an easel or an educational display board and when need be converted into a regular table.

This table can be of different shapes, lengths/sizes to be able to accommodate one or more students.

This table is height adjustable to accommodate different age groups.

The table top would be attached to the base of the table by a connecting rotating adjustable bar on either side that hinges the table top so as to have the capability to rotate the table top to either of its sides or at different angles.

The table top would be two sided with one side being computerized touch screen and the other side is a magnetic flat surface, a chalkboard surface or just plain table top surface (if used at home).

The base of the table would have stops which can be pulled out or indents that are inserted into the base of the table so as to position the table top at different angles.

More high-end models can have automated rotation of the table top.

The adjustable legs have rollers attached for ease of movement of the table.

### BRIEF DESCRIPTION OF THE DRAWINGS

FIG. 1 depicts all the main features of the table. The table is in a position where the table top is at an angle displaying the computer screen to children. This position can be used also by teachers to display documentaries, presentations, pictures, run phonics/math and other drills, play educative games with children and also as a regular whiteboard to teach students various subjects. The drawing shows the table top attached to the table base by pivotal and adjustable connecting bars on the two sides. There are headphone sockets on the top and bottom edge of the table top, USB port, speakers and a charging socket on the side edge of the table top (computerized side). The table base has pull out bars in the center indent to hold the table top at different angles. The picture also shows one kind of adjustable legs on rollers, but there could be different kinds of adjustable legs on rollers.

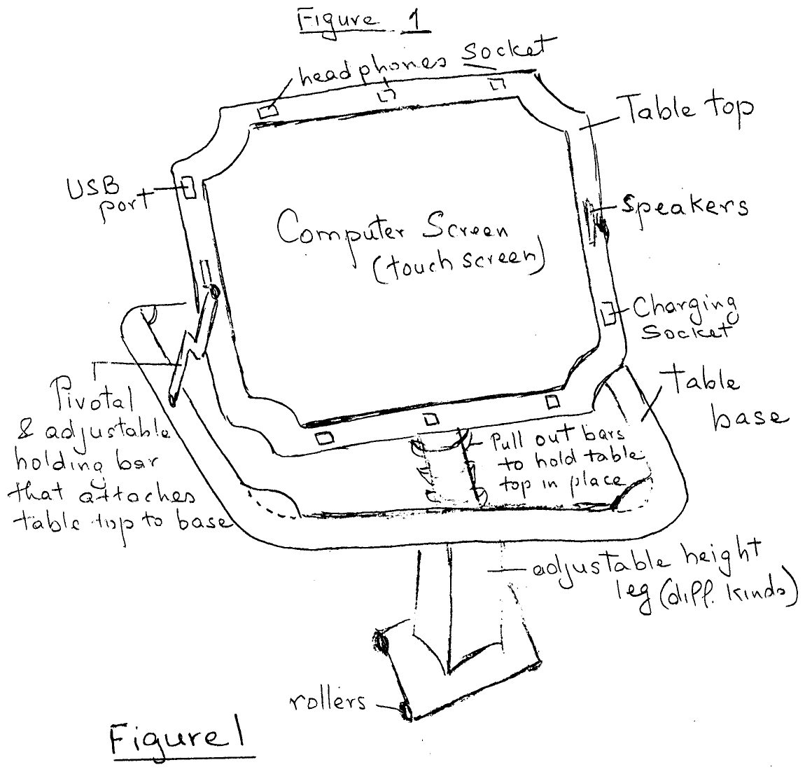

FIG. 2 displays the position of the table top in a horizontal position resting on the base of the table, with the computer screen facing towards the top. The table is placed in this position to enable children to play educative games with or without the accessories that go with the game being played. It can also be used as a desk where kids can complete electronic worksheets assigned by the teacher or complete an art project using the electronic touch screen. The picture shows how the screen can be divided into two or more sections for individual work or play.

FIG. 3 displays adjustable legs that can be of a different type than shown in the other drawings. The figure also displays icons for different subjects that can be selected by the teacher depending on what she wants to teach at that time. For eg. when its indoor play time the teacher/parent can click on the ‘Play station’ to access various games for the kids, when its Science time the teacher/parent can click on the ‘Science’ icon in order to teach a science topic or display an experiment etc, when its phonics or math time the teacher can click on the respective icon to access everything that's related to that subject and so forth. It also displays the stopper that would hold the table top in place.

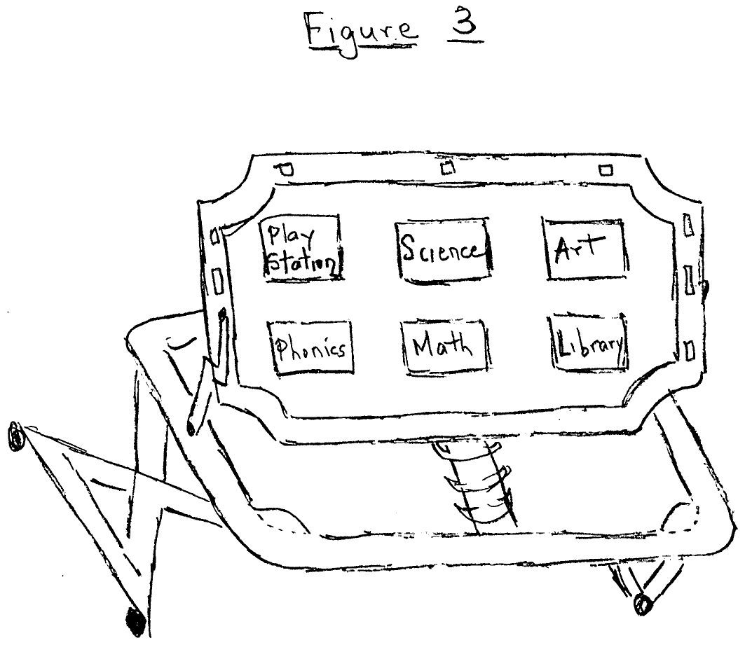

FIG. 4 displays the other side of the table top whereby the chalkboard or magnetic board side is facing the students held up in the upright position. Also, the edge of the tabletop is tapered or indented so all spills if any drip away from the computer screen. It also has a pull out handle on the top center to help lift the table top and place in different angles. Again this figure also shows how there can be a different kind of adjustable legs on wheels than shown in other figures.

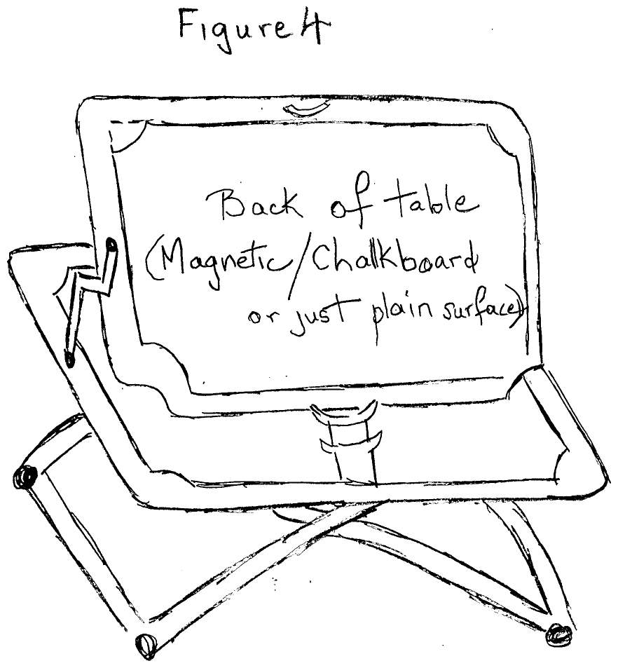

FIG. 5 shows the table top in a horizontal position lying on the base of the table with the magnetic, chalkboard or plain surface side facing upward. This configuration can be used for regular eating, drinking writing on paper. This configuration will help the user to use the table as a regular table.

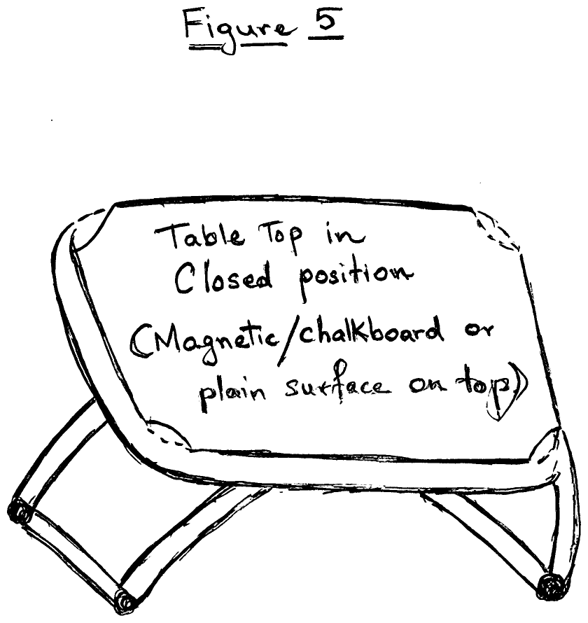

FIG. 6 shows how the table base can be indented or have pull out indents on the two sides to hold the table top at different angles. This can be instead of having the pull out slots in the center of the table base as shown in FIGS. 1 and 4.

FIG. 7 displays other types of adjustable legs on rollers that could be possible for the table.

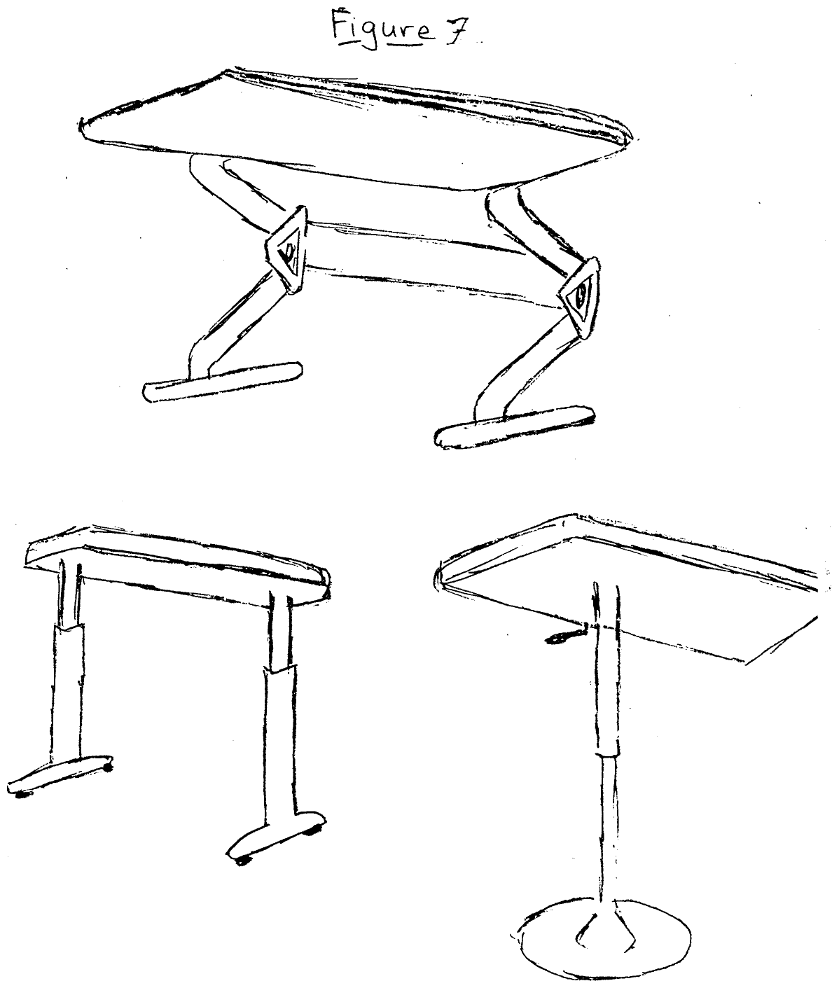

### DETAILED DESCRIPTION OF THE INVENTION

This computerized table has two parts. One is a table top and the second is the table base. The table top is attached to the table base by a hinged adjustable bar that can pivot the table top around so that either side of the table top can be used/displayed as needed. The bar is either zig zag or bolted so as to be flexible enough to rotate the table top and place it horizontally onto the table base or vertically at different angles.

One side of the table top would have a flat touch screen, tough glass computer (any shape/size), the other side would be a magnetic, chalkboard or plain surface. This table top is mounted on 2 sides by a (pivotal) holding bar that hinges the table top so as to rotate it at different angles to be used as an easel or any other presentation or activity device or place the table top horizontally on the table base to be used as a regular table or work desk. The rotation can be done manually or may be automated.

The table can be of various sizes or shape.

The table base has adjustable or/& removable leg/legs that are height adjustable with wheels that lock in place and unlock for easy movement around the room.

The table base is indented to have storage room for accessories that go with the table.

The other side of the table top that is magnetic or has a chalkboard surface can be used by teachers to teach.

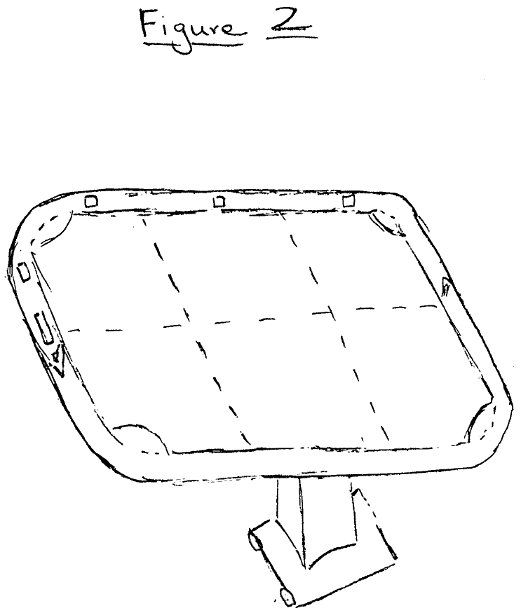

The computer is loaded with educational and/or fun individual or team play activities, Art, Music, phonics and math games and scientific explorations and documentaries etc. with the capability to change games or activities by adding or deleting apps onto it. The display screen can invert images so it can be seen right side up from both sides of the table top. The screen can be programmed so it can be divided into 2 or more parts for individual work/play of students (as shown in FIG. 2). Higher end models can also have 3D capabilities for games and STEM activities.

This hi-tech table can be battery operated or electrically charged. The computer screen is water resistant. The screen is scratch and crack resistant. The table top can be inverted either side up to either convert to a regular table or to convert to a play/activity station when placed in a horizontal position or kept at an angle to use as an easel or a presentation device.

This table has a capability of loading software games and activities like a normal tablet computer either directly from the internet, via WIFI, blue-tooth and/or other wireless or wired methods, loaded from a USB port or a memory card port. It is voice activated and has speakers to play music and interact in different ways. It also has headphone input option for each student's individual work. It can have either facial recognition, finger printing or other input options for the child to register his/her work.

The table comes with other accessories (that work in coordination with software's) like
a virtual paintbrush the child can pick to paint without actual paint. The paintbrush will sense the color it touches on the screen and use that color to paint. Then it will sense the water when dipped in to delete that color from the brush. The screen is either divided for individual work or group work. The art is automatically stored as a PDF in the child's folder.
It will have a toy train with rubber (or any other soft material) wheels that can run over train tracks when the screen displays a virtual train track, scenery, train stations, people getting off and on. Making various train sounds.
small cars/trucks/buses that the screen is sensitive to and can have it rolling through different city scenes etc (or any other roads through countries or highways or on race tracks, etc) Children can maneuver the cars through traffic signals and buildings over highways etc. It can stop to fill gas or just park.
it can also have hard rubber made crayons, color pencils in different colors which when touches the screen, colors the drawing/art accordingly, or a pencil to write worksheets. The software can be run for individual student art activity or group art/work. The individual or group art can be saved onto the children's file.
it can have a mouse that the children can move the cursor with to pop bubbles or catch fishes and drag them to a bucket or click and drag letters or blocks etc or any other games to improve their mouse skills. Different color mouse's can keep track of individual scores.
It can have a magnetic or screen sensitive fishing pole that could help the children go fishing when touching the screen. Different color poles can keep tract of individual scores.
Soft hammer that could hit onto frogs leaping out of the pond etc, or pirates out on a boat, or hammer in nails while building a house etc to improve hand eye coordination.
air hockey hitting dice.
Dot art or stamp art pens which the screen is sensitive to the color of the pen without it actually painting the screen.

Versatility of the Table—Soft-wares, Activities, Games That Can Be Loaded
Train table—A software that displays train tracks, that run through mountains, cities, valleys making sounds from the trains where children can stop their train at different stations and people can enter or get off the train. When two trains collide it can show the crash etc.
Art table—Different software's that could be used to do individual or group art work. Electronic plain paper is distributed to the individual stations for drawing. There is also the option to distribute pre-printed coloring sheets. Crayons that the computer can sense for color and can be used to draw by just touching and drawing on the screen without actually coloring the screen. The software should recognize the color of the crayon being used. Paint brushes that can sense the color picked on the screen and use that color to paint the section of the artwork being painted. Individual art can be recognized by the finger print button that can be pressed or facial recognition that can then file the Childs art in their respective folders when the save button is pressed and finally be emailed to their parents. Dot Art pens can also be made screen sensitive and used in a similar fashion for children to dot-art.
Software that displays a farm scene where children can feed the farm animals, take them grazing, rear the sheep or milk the cows, clean the horse or pigs, fruit pick or sow the vegetables, run the tractor or water and fertilize the plants. They could also listen to the sounds of the farm animals etc. When touching the animal they can hear a few facts about the animal. The software should load the farm scene such that children on both sides can have the farm displayed right side up or with an aerial view.
Software that displays a zoo where children can feed the animals, give the animals a bath make them do various tricks or just play with them. If they click on the animal it will give them some facts about the animal they clicked on or just say out the name. It can also have games where children can classify different animals as zoo, farm or wild or sea animals and various other classification groups.
Software that displays a city scene where children can have a person drive through the city in a car/bus/bike etc. Have the person go to the grocery store, school, post office, hospital or park. Make him do different chores etc.
Software that has games wherein the children can use the wireless mouse to pop bubbles, or catch fish, or pluck fruits from a tree and drag them into a basket, or snap the bees etc. Each mouse can be of a different color to keep track of scores. Similar kind of games that can use the magnetic fishing pole or a soft hammer head to improve hand eye coordination.
Software where children can use the soft hammer to hammer nails to build different things or pop bubbles or hit pirates on a ship or frogs leaping out of the pond etc to improve had eye coordination.
Software that would display the kitchen where children could mix, heat food, microwave, grate, chop vegetables and fruits, refrigerate food or just load the dishes in the dishwasher. They could even serve the food to people at the dining table.
Software that could be a doll house or a princess castle of their choice that they can furnish with furniture, dolls and have the dolls party around, dress up, watch tv, brush their teeth or cook or change into different attires etc.
Software that displays a bowling alley for children to go bowling with their fingers.
Software that would have the children place the planets in their order from the sun. If they press on different things in space like a comet it would name each thing they touch and give a fact or two. Fly a rocket through space and visualize what an astronaut would see on its way.
Software with different kinds of building blocks to build trains, buildings, bridges, homes being provided the tools to build it etc.
Table can convert to an air hockey table with an actual air hockey hitting dice that can sense the dice to hit it in the hole.
Software where kids can mix match substances and see their reactions. Scientific experiments with kids mixing ingredients and watching reactions without actually handling them.
Software that children can pick their own story book to read or have headphones that could be plugged on for individual reading time.
Table can be tilted to turn into a TV screen to display kids different scientific experiments or educational documentaries.
Software that could load puzzles of different levels.
Solving puzzles, reading books, phonics and math games (played individually or as a group) are just few more activities that this hi-tech table will be capable of.
Software that has a virtual robot moving which children can program with clicking right/left/up/down arrow to move around. Higher level for older kids
Bow and arrow games. Golfing games.
Car race track. Keeping cars on the road and navigating through obstacles to reach the finish line.
Musical instruments drums, xylophone, piano where children can listen to the different sounds, instruments make, when played.
Memory games
Software for teachers to make it a writing/drawing board when placed as an easel.
Software where kids can trace shapes, alphabets numbers drawings etc.
The table top can be tilted to act as a chalk board and be flattened to be a table for eating, drinking,
writing etc.

The same table when flipped over becomes a regular table where students can eat, drink, write, draw etc. The same table top if placed at an angle, one side of which can be used as a magnetic board or a chalk board or easel the other (computerized) side when rotated (facing the children) can be used as a presentation device or writing board using the software that opens a plain white sheet for the teacher to write (with a special touch no-ink pen) and erase (with a screen sensitive eraser) without actually writing on the screen.

The same table (single use) can be used in higher grades for students to complete test electronically, where the teacher will have a similar table (that would act as a central portal) that could view the work of individual students live as they are working on it. The computer could auto-correct and grade class work and file to individual student files. The students could also read books electronically or hear a documentary using their headsets. Students could use this same table to write worksheets or do a research. Invert the table top and it would become a regular table.

1. A hi-tech Computerized Table comprising:
a dual sided table top,
a flexible bar that can rotate the said table top and attach it to the base of the table,
a base table on which the said table top would rest or be adjusted at different angles,
adjustable legs on which the said base table rest.

2. A hi-tech Computerized table as in claim 1 could come in various shapes and sizes.

3. A hi-tech Computerized table as in claim 1 wherein said table top has 2 sides one which has a computerized touch screen and the other side which has a magnetic or chalkboard surface or just a regular table top surface.

4. A hi-tech Computerized table as in claim 1 wherein the said computerized side of table top as in claim 2 has a water/scratch resistant touch screen computer with WIFI, bluetooth and/or other wireless or wired methods, charging outlet, USB port or a memory card port, is voice activated and has speakers to play music and interact in different ways, has headphone input option for each student's individual work, with a possibility of having either facial recognition, finger printing or other input options for the child to register his/her work and the screen is scratch and crack resistant

5. A hi-tech Computerized table as in claim 1 wherein the side other than the computerized side of the table top as mentioned in claim 2 has either a magnetic surface or chalkboard surface or just a regular surface as required by the end user.

6. A hi-tech Computerized table as in claim 1 wherein the said table top has connecting bars on either side that hinges the table top to the base of the table and that can rotate the table top around at different angles and also be able to turn the table top to its horizontal position to rest on the table base with either side facing the top which can be operated manually or automated.

7. A hi-tech Computerized table as in claim 1 wherein the said base of the table is indented for storage of writing/drawing supplies and has slots or grooves on its sides or in the middle so as to hold the table top at different angles.

8. A hi-tech computerized table as in claim 1 wherein the table top with base is mounted on adjustable height legs to serve different age groups.

9. A hi-tech Computerized table wherein the table flat side which is either magnetic or chalkboard can be used by teachers as a magnetic board or a chalkboard easel to write with markers/chalk for teaching purposes, or the same can be used as a regular table for eating, drinking, drawing or writing purposes when kept at a horizontal position.

10. The hi-tech computer table wherein the table top with the computerized side is loaded with educational and/or fun individual or team play activities, Art, Music, phonics and math games and scientific explorations and documentaries etc. with the capability to change games or activities by adding or deleting apps onto it.

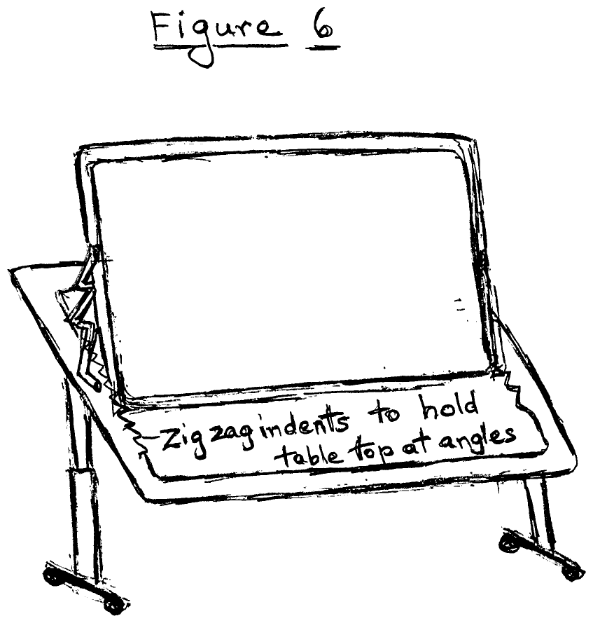

11. The hi-tech computer table wherein the display screen can invert images so it can be seen right side up from both sides of the table top and the screen can be programmed so it can be divided into 2 or more parts for individual work/play of students (as shown in FIGS. 6A and 6B); higher end models can also have 3D capabilities for games and STEM activities.

12. This hi-tech computerized table can be battery operated or electrically charged.

13. The table top can be inverted either side up to either convert to a regular table or to convert to a play station or kept at an angle to use as an easel or a presentation device.

14. This table has a capability of loading software games and activities like a normal tablet computer either directly from the internet, via WIFI, blue-tooth and/or other wireless or wired methods, loaded from a USB port or a memory card port, It is voice activated and has speakers to play music and interact in different ways and also has headphone input option for each student's individual work, It can have either facial recognition, finger printing or other input options for the child to register his/her work.

15. The hi-tech computerized table comes with accessories like train and other transportation vehicles, screen sensitive paint brushes, crayons, pencils, soft hammer, wireless mouse, Air hockey puck that can be used in coordination with the different software's to make it a virtual experience.
